(19) United States
(12) Patent Application Publication
(10) Pub. No.: US 2024/0352258 A1
(43) Pub. Date: Oct. 24, 2024

(54) DARK PRIMER COATINGS WITH HIGH LIDAR REFLECTIVITY

(71) Applicant: BASF COATINGS GMBH, Muenster (DE)

(72) Inventors: Manoj KAYARKATTE, Mangalore (IN); Qingling ZHANG, Southfield, MI (US); Hitesh MAHAJAN, Mangalore (IN); Rajkumar JANA, Mangalore (IN); Donald H. CAMPBELL, Hartland, MI (US)

(21) Appl. No.: 18/579,147

(22) PCT Filed: Aug. 30, 2022
(86) PCT No.: PCT/EP22/74116

§ 371 Date: Jan. 12, 2024

(30) Foreign Application Priority Data
Aug. 30, 2021 (IN) 202141039183
May 16, 2022 (EP) 22173579.8

(51) Int. Cl. C09D 5/00; C08K 3/013; C08K 3/22; C09D 5/33; C09D 7/41; C09D 7/61; C09D 133/08

(52) U.S. Cl. CPC C09D 5/002; C09D 5/004; C09D 7/41; C09D 7/61; C09D 133/08; C08K 3/013; C08K 2003/2241; C08K 2201/019

(57) ABSTRACT

Disclosed herein is a primer coating composition, which is free of or essentially free of metal effect pigments, including besides water and/or organic solvent(s), a film-forming polymer, optionally a crosslinking agent and further a pigment mixture P-C including in turn at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation. Further disclosed herein are methods of forming a primer coating film and layer, an at least partially coated substrate, a multilayer coating system and a method for preparing the multilayer coating system.

The present invention relates to a primer coating composition, which is free of or essentially free of metal effect pigments, comprising besides water and/or organic solvent(s), a film-forming polymer and optionally a crosslinking agent, further a pigment mixture P-C comprising in turn at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation, wherein pigment P-C1 is present in an amount in a range of from 0.1 to 20.0 wt.-% and pigment P-C2 is present in an amount in a range from 0.2 to 40.0 wt.-%, in each case based on the total weight of the primer coating composition, and wherein a primer coating obtained from applying the primer coating composition to a substrate has a brightness value L* according to the CIELAB system at 45° of no more than 38, methods of forming a primer coating film and layer, an at least partially coated substrate, a multilayer coating system and a method for its production.

### BACKGROUND OF THE INVENTION

In automotive industry, one of the new requirements, which is coming up, is to provide coatings with good infrared reflectivity. A good infrared reflective coating helps to keep the car cool. For example, U.S. Pat. No. 6,366,3971 B1 relates to an IR radiation reflector having an IR reflecting layer and an IR permeable layer formed on the IR reflecting layer. U.S. Pat. No. 6,366,3971 B1 aims at providing an IR radiation reflector having good IR reflecting characteristics and a wide range of possible colors. Further, JP 2014-210856 A relates to a coating film with low lightness. The coating composition used for preparing said coating film includes a black pigment reflecting and/or transmitting IR rays and a transparent blue pigment and has a lightness L* of 0.1 to 7. JP 2014-210856 A aims at providing a coating, which does not heat up, but still has jet black color characteristics. U.S. Pat. No. 10,619,053 B2 discloses a solar reflective coating composition comprising inter alia two different kinds of NIR-transparent perylene pigments such as green-shade or purple-shade perylene pigments and a NIR-reflective pigment such as titanium dioxide. A cured coating obtained therefrom exhibits an off-white or grey color and has an L* value in a range of from 40 to 95 at an angle of 10°. U.S. Pat. No. 10,619,053 B2 aims at preventing a heat build-up in substrates coated with said coating composition.

However, a good infrared reflective coating also helps vehicles with ADAS (Advanced Driver Assistance Systems), in particularly with LiDAR (Light Detection and Ranging). ADAS rely highly rely on remote sensing technologies on optical or electromagnetic means for position and speed determination. LiDAR is a remote-sensing technology that can be deployed within vehicles as the primary source of object recognition. By illuminating the surrounding environment with Laser light (typically 905 nm or 1550 nm) LiDAR maps distance to objects in its path in real-time by measuring the reflection with a sensor. For example, if an object gets too close to the vehicle, a collision with the object can be avoided. Since LiDAR utilizes near-infrared light (near-IR light or NIR light) as its source of illumination, the technology has to overcome several challenges. Apart from the LiDAR instrument as such, one of the important factors for the accuracy of the measurement is the surface of the illuminated object. In case of automobiles and other vehicles, the surface is usually covered by a multilayer coating, which plays an important role in determining the LiDAR reflectivity.

The coating layers on vehicle bodies and parts thereof, starting from the substrate in this order, in OEM are typically a conversion coating layer, an electrodeposition coating layer, such as a cathodic electrodeposition layer, a primer layer (also sometimes referred to as filler layer), at least one basecoat layer, and on top of the basecoat layer a clearcoat layer as top coat. A typical OEM multilayer coating layer thus comprises a primer, at least one basecoat and a clearcoat. The clearcoat layer is a visibly transparent layer and is usually also transparent to IR radiations. Basecoats often contain organic pigments and/or effect pigments such as metal flakes. A dark primer is often used underneath the basecoat layer to compliment the dark color of the basecoat. To achieve dark primer, carbon black is generally added to the formulation. Carbon black, however, absorbs infrared wavelengths, and thus leads to undesired heat build-ups. EP 2 323 777 B1 relates to a production of a dark color multilayer coating on a substrate, wherein said multilayer comprises in this sequence on the substrate: a layer A′, a layer B′ and a clearcoat layer. Layer B′ is prepared from a composition B comprising at least 50 w.-% of a black pigment with a low NIR-absorption, i.e., a high NIR-transmission, such as a perylene black pigment, and optionally up to 50 wt.-% of a further pigment, based in each case on the pigment content of composition B, wherein layer B′ exhibits only a low NIR-absorption. The dark color multilayer exhibits a brightness L* at an angle of 45° of at most 10. EP 2 323 777 B1 aims at providing a dark multilayer coating, which does not heat up. U.S. Pat. No. 8,679,617 B2 discloses a solar reflective coating system comprising inter alia a second layer present below a first coating layer, wherein said second layer comprises a visibly absorbing infrared transparent pigment as well as a thin flake metal or metal alloy infrared reflective pigment. Using such a thin flake metal or metal alloy pigment, i.e., a metal effect pigment, in the second layer, however, is disadvantageous since, due to its presence, an undesired high angle dependency in LiDAR application results: the LiDAR reflectivity of such a coating layer at an angle of incidence of 45° is typically below 9% or even much lower such as below 5%.

In recent years some approaches were developed to improve the LiDAR reflectivity of multilayer coatings, particularly those applied to vehicles. In a first approach, NIR-reflective pigments are contained in the basecoat layer. The NIR light passes the non-NIR-absorbing (NIR-transparent) protective clearcoat layer and is reflected by NIR-reflective pigment(s) in the basecoat layer. However, the basecoat layer is usually the layer, which determines the color and/or effect characteristics of the multilayer automotive coatings. Therefore, as mentioned hereinbefore, basecoats usually contain organic pigments and effect pigments such as metal flakes. These flake pigments, however, are transparent in the near-infrared (NIR) region. Thus, in a different, second approach, the NIR light passes the non-NIR-absorbing protective clearcoat layer and also the basecoat layer containing non-NIR-absorbing coloring and/or effect pigments, but must then be reflected by the primer layer. Due to the transparency at NIR of the aforementioned pigments within the basecoat, the NIR reflectivity of the primer plays a pivotal role in determining the reflectivity of such systems. While bright primers are in general NIR reflective, dark primers including ones containing carbon blacks as mentioned hereinbefore are usually NIR absorbing. When designing a primer to be used as LiDAR reflective primer, one of the critical aspects to be further considered is light transmission, in particular in the wavelength region from 280 nm to 500 nm (ultraviolet region). High energy 400-500 nm wavelength light can penetrate through the primer layer and degrade the electrodeposition coating layer underneath. TiO₂ is the most widely used primary pigment, that absorbs UV radiations, but scatters in visible radiations. Some scattered low wavelength radiations (400 nm to 500 nm) may, however, reach the electrodeposition coating layer. Carbon black has a good absorption of wavelength across the range and helps to mitigate such degradation and to reduce UV transmission. However, the use of carbon black has the aforementioned disadvantages.

Thus, there is a need to provide further improved dark primer coatings, which not only have a high IR reflectivity/LiDAR reflectivity such as a LiDAR reflectivity above 45% or above 50%, but which also provide a good hiding at the UV visible range such as a UV transmission below 0.005 in a wavelength region of from 280-500 nm. At the same time such a primer should not allow any undesired heat build-ups originating from any of its constituents such as carbon black, in particular when being part of a multilayer coating system as used in the automotive industry, and should provide the same dark color as conventional carbon black containing primer coatings.

### Problem

It has been therefore an object underlying the present invention to provide dark primer coatings, which not only have a high IR reflectivity/LiDAR reflectivity such as a LiDAR reflectivity above 45% or above 50%, but which also display a good hiding at the UV visible range such as a UV transmission below 0.005 in a wavelength region of from 280-500 nm. At the same time such a primer should not allow any undesired heat build-ups originating from any of its constituents such as carbon black, in particular when being part of a multilayer coating system as used in the automotive industry, and should provide the same dark color as conventional carbon black containing primer coatings.

### Solution

This object has been solved by the subject-matter of the claims of the present application as well as by the preferred embodiments thereof disclosed in this specification, i.e., by the subject matter described herein.

A first subject-matter of the present invention is a primer coating composition, which is free of or essentially free of metal effect pigments, comprising
as at least one constituent P-A at least one film-forming polymer P-A1, and in case of P-A1 being externally crosslinkable, at least one crosslinking agent P-A2,
water and/or one or more organic solvents as constituent(s) P-B,
a pigment mixture as at least one constituent P-C comprising at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation,
   wherein pigment P-C1 is present in an amount in a range of from 0.1 to 20.0 wt.-%, based on the total weight of the primer coating composition, and pigment P-C2 is present in an amount in a range from 0.2 to 40.0 wt.-%, based on the total weight of the primer coating composition, and
   wherein a primer coating obtained from applying the primer coating composition to a substrate has a brightness value L* according to the CIELAB system at 45° of no more than 38.

Preferably, a primer coating obtained from applying the primer coating composition to a substrate and curing the resulting primer coating film to obtain the primer coating has a brightness value L* according to the CIELAB system at 45° of no more than 38, more preferably of no more than 35, even more preferably of no more than 30. Preferably, curing takes place at about 140° C. for 25 minutes.

A further subject-matter of the present invention is a method of forming a primer coating film at least partially onto at least one surface of a substrate, wherein said method comprises at least step (a), namely
(a) applying the inventive primer coating composition at least partially onto at least one surface of an optionally pre-coated substrate to form a primer coating film on the surface of the substrate.

A further subject-matter of the present invention is a method of forming a primer coating layer at least partially onto at least one surface of a substrate, wherein said method comprises at least step (a) as defined hereinbefore and at least step (b), namely
(b) curing the primer coating film obtained after step (a) to obtain a primer coating layer.

A further subject-matter of the present invention is a coating film obtainable from the inventive primer coating composition or by the inventive method of forming a primer coating film and a coating layer obtainable from the inventive primer coating composition or by the inventive method of forming a primer coating layer.

A further subject-matter of the present invention is an at least partially coated substrate obtainable by the inventive method of forming a primer coating layer, wherein the substrate as such prior to performing said method preferably is not or essentially not LiDAR-reflective.

A further subject-matter of the present invention is a multilayer coating system being present on an optionally pre-coated substrate and comprising at least three coatings layers L1, L2 and L3 being different from one another, namely
a first coating layer L1 applied over at least a portion of an optionally pre-coated substrate,
a second coating layer L2 applied over the first coating layer L1, and
a third top coating layer L3 applied over the second coating layer L2,
wherein the first coating layer L1 is formed from the inventive primer coating composition and the second coating layer L2 is formed from a basecoat composition different from the primer coating composition, and the third coating layer L3 is formed from a topcoat, preferably clearcoat, composition different from both the primer coating composition and from the basecoat composition.

A further subject-matter of the present invention is a method for preparing the inventive multilayer coating system comprising at least steps (1), (2), (3) and (4), namely
(1) applying an inventive primer coating composition to at least a portion of an optionally pre-coated substrate and forming a first coating film on at least a portion of the optionally pre-coated substrate,
(2) applying a basecoat composition different from the primer coating composition applied in step (1) to the first coating film present on the substrate obtained after step (1) and forming a second coating film, which preferably is adjacent to the first coating film,
(3) applying a coating composition different from the compositions applied in steps (1) and (2) to the second coating film present on the substrate obtained after step (2) and forming a third coating film, which is preferably adjacent to the second coating film, wherein said coating composition is preferably a clearcoat composition, and
(4) jointly curing at least the second and third coating films applied in steps (2) and (3) and optionally also the first coating film applied in step (1) in case said first coating film was not cured prior to performing of step (2) to obtain a multilayer coating system comprising at least the first, the second and the third coating layers L1, L2 and L3.

A further subject-matter of the present invention is a use of the inventive coating film or layer and/or of the at least partially coated inventive substrate and/or of an object produced from said substrate and/or of the inventive multilayer coating system in LiDAR visibility applications concerning vehicles and parts thereof.

It has been in particular surprisingly found that the inventive primer coating composition is able to provide a dark primer coating, which has both a high IR reflectivity, a high NIR reflectivity and thus a high LiDAR reflectivity. In particular, it has been found that a LiDAR reflectivity, measured at an angle of incidence (AOI) of 0°, of at least 40%, preferably of at least 45%, more preferably of at least 50%, even more preferably of at least 55%, still more preferably of at least 60%, yet more preferably of at least 65%, in particular of at least 70%, can be achieved. LiDAR reflectivity is measured according to the method disclosed in the method section. In particular, it has been further found that an infrared solar reflectance (IRSR) of more than 30%, preferably of more than 35%, even more preferably of more than 40%, can be achieved. IRSR is measured according to the method disclosed in the method section.

It has been further surprisingly found that the inventive primer coating composition is able to provide a dark primer coating, which also displays a good hiding at the UV visible range (UV Vis) such as a UV transmission below 0.005 in a wavelength region of from 280-500 nm. In particular, it has been found that a UV Vis transmission of below 0.005, preferably of below 0.003, more preferably 50.002, can be achieved. UV Vis transmission is measured according to the method disclosed in the method section.

It has been further found that the inventive primer coating composition is able to provide a dark primer coating, which prevents any undesired heat build-ups originating from any of its constituents such as carbon black, in particular when being part of a multilayer coating system as used in the automotive industry, as no or essentially no carbon black has to be used for providing the primer coating. In particular, the primer coating composition is free or essentially free of any carbon black pigments. Rather, the primer coating composition makes instead use or other suitable organic or inorganic black pigments, in particular perylene pigments such as Paliogen® black L0086.

Moreover, it has been found that the inventive primer coating composition is able to provide a dark primer coating, which has the same or substantially the same dark color as conventional carbon black containing primer coatings. A measure for this is the weighted average of the color difference (mDE*) between an inventive primer coating and a comparable conventional carbon black containing primer.

### DETAILED DESCRIPTION OF THE INVENTION

The term “comprising” in the sense of the present invention, in connection for example with the primer coating composition, preferably has the meaning of “consisting of”. With regard, e.g., to the primer coating composition, it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the coating compositions such as the primer coating composition add up to 100 wt.-%, based in each case on the total weight of the coating composition such as the primer coating composition.

As used herein, the term “near-IR” or “near-infrared radiation or light” or “NIR” refers to electromagnetic radiation in the near-infrared range of the electromagnetic spectrum. Such near-IR electromagnetic radiation may have a wavelength from 800 nm to 2500 nm, such as from 850 to 2000 nm or such as from 900 nm to 1600 nm. In particular, the NIR light used has a wavelength from 880 nm to 930 nm with 905 nm as center wavelength. The near-IR electromagnetic radiation source that may be used in the present invention to produce NIR light includes, without limitation, light emitting diodes (LEDs), laser diodes or any light source that is capable of emitting electromagnetic radiation having a wavelength from 800 nm to 2500 nm (in the near-IR range). The near-IR electromagnetic radiation source may be used in a LiDAR system. The LiDAR system may utilize lasers to generate electromagnetic radiation with a wavelength from 900 nm to 1600 nm.

The term “pigment” is known to the skilled person, from DIN 55943 (date: October 2001), for example. A “pigment” in the sense of the present invention refers preferably to a constituent in powder or flake form which is substantially, preferably entirely, insoluble in the medium surrounding them, such as in one of the coating compositions, for example. Pigments are preferably colorants and/or substances which can be used as pigment on account of their magnetic, electrical and/or electromagnetic properties. Pigments differ from “fillers” such as barium sulfate preferably in their refractive index, which for pigments is 1.7. The term “filler” is known to the skilled person, from DIN 55943 (date: October 2001), for example. Pigments can be inorganic or organic.

### Primer Coating Composition

The primer coating composition is free or essentially free of any metal effect pigments, in particular free or essentially free of any aluminum pigments. Preferably, the primer coating composition is free or essentially free of any effect pigments at all. The terms “effect pigment” and “metal effect pigment” are described hereinafter in more detail. “Essentially free” in this context preferably means that no metal effect pigment or effect pigment is added on purpose and that preferably, their amount, if present, is below 0.1 wt.-%, in particular below 0.01 wt.-%, most preferably below 0.001 wt.-%, based on the total weight of the primer coating composition.

The primer coating composition can be aqueous (waterborne) or organic solvent(s) based (solventborne, non-aqueous). Preferably, it is aqueous.

The term “solventborne” or “non-aqueous” is understood preferably for the purposes of the present invention to mean that organic solvent(s), as solvent(s) and/or as diluent(s), is/are present as the main constituent of all solvents and/or diluents present in the respective coating composition such as in the primer coating composition if the respective coating composition is solventborne. Preferably, organic solvent(s) are present in an amount of at least 35 wt.-%, based on the total weight of the coating composition. A solventborne coating composition preferably includes an organic solvent(s) fraction of at least 40 wt.-%, more preferably of at least 45 wt.-%, very preferably of at least 50 wt.-%, based in each case on the total weight of the coating composition. All conventional organic solvents known to those skilled in the art can be used as organic solvents. The term “organic solvent” is known to those skilled in the art, in particular from Council Directive 1999/13/EC of 11 Mar. 1999. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. A solventborne coating composition preferably is free or essentially free of water. The term “essentially” in this context preferably means that no water is added on purpose when preparing the coating composition.

The term “waterborne” or “aqueous” is understood preferably for the purposes of the present invention to mean that water is present as the main constituent of all solvents and/or diluents present an aqueous coating composition such as in the primer coating composition. Preferably, water is present in an amount of at least 35 wt.-%, based on the total weight of the coating composition. An aqueous coating composition preferably includes a water fraction of at least 40 wt.-%, more preferably of at least 45 wt.-%, very preferably of at least 50 wt.-%, based in each case on the total weight of the coating composition. The fraction of organic solvent(s) is preferably <20 wt.-%, more preferably in a range of from 0 to <20 wt.-%, very preferably in a range of from 0.5 to 20 wt.-% or to 17.5 wt.-% or to 15 wt.-% or to 10 wt.-%, based in each case on the total weight of the coating composition.

The term “primer” or “primer coating composition” is known to a person skilled in the art. A primer typically is applied after the substrate has been provided with a cured electrodeposition coating layer. The cured electrodeposition coating film is present underneath and preferably adjacent to the cured primer coating film. Thus, a primer coating composition can be applied to an optionally pre-coated substrate and forming a primer coating film on the optionally pre-coated substrate. Then, an optional curing step of this primer coating film is possible before any further coating compositions are applied.

### Primer Coating Composition—Constituent(s) P-A

The primer coating composition comprises as at least one constituent P-A at least one film-forming polymer P-A1, and in case of P-A1 being externally crosslinkable, at least one crosslinking agent P-A2.

The at least one film-forming polymer P-A1 functions as binder. For the purposes of the present invention, the term “binder” is understood in accordance with DIN EN ISO 4618 (German version, date: March 2007) to be the non-volatile constituent of a coating composition, which is responsible for the film formation. The term includes crosslinkers such as crosslinking agents P-A2 and additives if these represent non-volatile constituents. Pigments and/or fillers contained therein are thus not subsumed under the term “binder”. Preferably, the at least one polymer P-A1 is the main binder of the coating composition. As the main binder in the present invention, a binder component is preferably referred to, when there is no other binder component in the coating composition, which is present in a higher proportion based on the total weight of the coating composition.

The term “polymer” is known to the person skilled in the art and, for the purposes of the present invention, encompasses polyadducts and polymerizates as well as polycondensates. The term “polymer” includes both homopolymers and copolymers.

The at least one polymer used as constituent P-A1 may be self-crosslinking or non-self-crosslinking. Suitable polymers which can be used are, for example, known from EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer used as constituent P-A1 is preferably selected from the group consisting of polyurethanes, polyureas, polyesters, polyamides, polyethers, poly(meth)acrylates and/or copolymers of the structural units of said polymers, in particular polyurethane-poly(meth)acrylates and/or polyurethane polyureas. The at least one polymer used as constituent P-A1 is particularly preferably selected from the group consisting of polyurethanes, polyesters, poly(meth)acrylates and/or copolymers of the structural units of said polymers. The term “(meth) acryl” or “(meth) acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), in European patent application EP 0 228 003 A1, page 3, line 24 to page 5, Line 40, European Patent Application EP 0 634 431 A1, page 3, line 38 to page 8, line 9, and international patent application WO 92/15405, page 2, line 35 to page 10, line 32.

Preferred polyethers are, e.g., described in WO 2017/097642 A1 and WO 2017/121683 A1.

Preferred polyesters are described, for example, in DE 4009858 A1 in column 6, line 53 to column 7, line 61 and column 10, line 24 to column 13, line 3 or WO 2014/033135 A2, page 2, line 24 to page 7, line 10 and page 28, line 13 to page 29, line 13 described. Likewise preferred polyesters are polyesters having a dendritic structure or star-shaped structure, as described, for example, in WO 2008/148555 A1.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred (meth)acrylic copolymers are OH-functional. Hydroxyl-containing monomers include hydroxy alkyl esters of acrylic or methacrylic acid, which can be used for preparing the copolymer. Non-limiting examples of hydroxyl-functional monomers include hydroxyethyl(meth)acrylate, hydroxypropyl(meth)acrylates, hydroxybutyl-(meth)acrylates, hydroxyhexyl(meth)-acrylates, propylene glycol mono(meth)acrylate, 2,3-dihydroxypropyl(meth)acrylate, pentaerythritol mono(meth)acrylate, polypropylene glycol mono(meth)acrylates, polyethylene glycol mono(meth)acrylates, reaction products of these with epsilon-caprolactone, and other hydroxyalkyl-(meth)acrylates having branched or linear alkyl groups of up to about 10 carbons, and mixtures of these. Hydroxyl groups on a vinyl polymer such as an (meth)acrylic polymer can be generated by other means, such as, for example, the ring opening of a glycidyl group, for example from copolymerized glycidyl methacrylate, by an organic acid or an amine. Hydroxyl functionality may also be introduced through thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-proanediol, 4-mercapto-1-butanol, and combinations of these. Any of these methods may be used to prepare a useful hydroxyl-functional (meth)acrylic polymer. Examples of suitable comonomers that may be used include, without limitation, α,β-ethylenically unsaturated monocarboxylic acids containing 3 to 5 carbon atoms such as acrylic, methacrylic, and crotonic acids and the alkyl and cycloalkyl esters, nitriles, and amides of acrylic acid, methacrylic acid, and crotonic acid; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic alcohols containing 1 to 20 carbon atoms, such as methyl, ethyl, propyl, isopropyl, n-butyl, isobutyl, tert-butyl, hexyl, 2-ethylhexyl, dodecyl, 3,3,5-trimethylhexyl, stearyl, lauryl, cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5,-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, a-methyl styrene, vinyl toluene, 2-vinyl pyrrolidone, and p-tert-butylstyrene. The (meth)acrylic copolymer may be prepared using conventional techniques, such as by heating the monomers in the presence of a polymerization initiating agent and optionally a chain transfer agent.

Suitable poly(meth)acrylates are also those which can be prepared by multistage free-radical emulsion polymerization of olefinically unsaturated monomers in water and/or organic solvents. Examples of seed-core-shell polymers (SCS polymers) obtained in this manner are disclosed in WO 2016/116299 A1.

Preferred polyurethane-polyurea copolymers are polyurethane-polyurea particles, preferably those having a Z-average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

The polymer used as constituent P-A1 preferably has reactive functional groups which enable a crosslinking reaction. Any common crosslinkable reactive functional group known to those skilled in the art can be present. Preferably, the polymer used as constituent P-A1 has at least one kind of functional reactive groups selected from the group consisting of primary amino groups, secondary amino groups, hydroxyl groups, thiol groups, carboxyl groups and carbamate groups. Preferably, the polymer used as constituent P-A1 has functional hydroxyl groups and/or carbamate groups.

Preferably, the polymer used as constituent P-A1 is hydroxyl-functional and more preferably has an OH number in the range of 15 to 400 mg KOH/g, more preferably from 20 to 250 mg KOH/g.

The polymer used as constituent P-A1 is particularly preferably a hydroxyl-functional polyurethane-poly (meth) acrylate copolymer, a hydroxyl-functional polyester and/or a hydroxyl-functional polyurethane-polyurea copolymer.

In addition, the primer coating composition may contain at least one typical crosslinking agent P-A2 known per se. Crosslinking agents are to be included among the film-forming non-volatile components of a coating composition, and therefore fall within the general definition of the “binder”.

All conventional crosslinking agents can be used. This includes melamine resins, preferably melamine aldehyde resins, more preferably melamine formaldehyde resins, blocked polyisocyanates, polyisocyanates having free (unblocked) isocyanate groups, crosslinking agents having amino groups such as secondary and/or primary amino groups, and crosslinking agents having epoxide groups and/or hydrazide groups, as well as crosslinking agents having carbodiimide groups, as long as the functional groups of the particular crosslinking agent are suitable to be reacted with the crosslinkable functional groups of the film-forming polymers used as binders in a crosslinking reaction. For example, a crosslinking agent having blocked or free isocyanate groups can be reacted with a film-forming polymer having crosslinkable OH-groups and/or amino groups at elevated temperatures in case of 1K formulations and at ambient temperature in case of 2K formulations.

If a crosslinking agent is present, it is preferably at least one aminoplast resin and/or at least one blocked or free polyisocyanate, preferably an aminoplast resin. Among the aminoplast resins, melamine resins such as melamine formaldehyde resins are particularly preferred. Preferably, the melamine aldehyde resins, preferably the melamine formaldehyde resins, in each case bear at least one of imino groups, alkykol groups and etherified alkylol groups as functional groups, which are reactive towards the functional groups of polymer P-A1. Examples of alkylol groups are methylol groups.

### Primer Coating Composition—Constituent(s) P-B

The primer coating composition comprises water and/or one or more organic solvents as constituent(s) P-B. This has been described hereinbefore in connection with the terms “aqueous” and “solventborne”.

### Primer Coating Composition—Constituent(s) P-C Including P-C1, P-C2 and P-C3

The primer coating composition comprises a pigment mixture as at least one constituent P-C comprising in turn at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation. The term “NIR-radiation” has been defined hereinbefore and in particular covers a wavelength region from 800 nm to 2500 nm, such as from 850 to 2000 nm or such as from 900 nm to 1600 nm, most preferably at least a region of from 880 nm to 930 nm with 905 nm as center wavelength. It is, of course, possible that the primer coating composition comprises a pigment mixture P-C comprising in turn at least two pigments P-C1, one being transparent or substantially transparent to NIR-radiation, and one being reflective or substantially reflective to NIR-radiation, and at least one pigment P-C2. Preferably, the pigment P-C1 is transparent or substantially transparent to NIR-radiation. As the primer coating composition is free or essentially free of any metal effect pigment it is clear that none of the pigments present therein including the pigments in the pigment mixture P-C can be such a metal effect pigment.

Pigment P-C1 is transparent or substantially transparent to NIR-radiation or is reflective or substantially reflective to NIR-radiation, whereas pigment P-C2 is necessarily reflective or substantially reflective to NIR-radiation. The term “substantially” in connection with the term “substantially transparent” preferably means that the main part of the NIR radiation wavelength region, preferably of the region of 800 nm to 2500 nm, such as from 850 to 2000 nm or such as from 900 nm to 1600 nm, is transmitted by the respective pigment, more preferably at least 80% or 90% or 95% of the wavelength region. The term “substantially” in connection with the term “substantially reflective” preferably means that 25 to <100% of the NIR radiation wavelength region from 900 nm to 1600 nm is reflected by the respective pigment.

Pigment P-C1 is present in an amount in a range of from 0.1 to 20.0 wt.-%, preferably of from 0.2 to 15.0 wt.-%, more preferably of from 0.5 to 12.0 wt.-%, even more preferably of from 1.0 to 10.0 wt.-%, still more preferably of from 1.5 to 8.5 wt.-%, yet more preferably of from 2.0 to 7.0 wt.-%, based on the total weight of the primer coating composition, and pigment P-C2 is present in an amount in a range from 0.2 to 40.0 wt.-%, preferably of from 0.5 to 35.0 wt.-%, more preferably of from 1.0 to 30.0 wt.-%, even more preferably of from 2.0 to 25.0 wt.-%, still more preferably of from 4.0 to 20.0 wt.-%, yet more preferably of from 5.0 to 18.0 wt.-%, based on the total weight of the primer coating composition.

Preferably, the amount of pigment P-C2 in the primer coating composition exceeds the amount of pigment P-C1, more preferably in that the relative weight ratio of pigment P-C2 to P-C1 is in a range of from 15:1 to 1.1:1, more preferably of from 12:1 to 1.5:1, even more preferably of from 10:1 to 2:1.

Preferably, the color of pigment P-C1 is characterized according to the CIELAB system at 45°, in that the L* value is less than 17, more preferred less than 15 and in that the a* and b* values are more than −4 and less than 9, more preferred less than 6 and most preferred less than 4 and preferably more than 0. Preferably, the color of pigment P-C2 is characterized according to the CIELAB system at 45°, in that the L* value is more than 85, preferably more than 90, the a* value is more than −2 and less than 2, preferably less than 0 and the b* value is less than 6 and preferably more than 0, more preferred more than 2 or 3.

Preferably,
the at least one black pigment P-C1 is a black pigment having a masstone color according to the CIELAB system at 45° with the values of L*<17, a*>−4 and <9, and b*>−4 and <9 and
the at least one white pigment P-C2 is a white pigment having a masstone color according to the CIELAB system at 45° with the values of L*>85, a*>−2 and <2, and b*>0 and <6.

The term “masstone color” or “masstone color with full hiding” is used and understood as it is commonly used and understood in colorimetry. The “masstone color” is defined as the color which is obtained by applying a coating layer containing the respective pigment to completely cover a black and a white substrate (typically a so-called “checker tile” being partially black and partially white is used) in a layer thickness, where no black and white color information shines through. The respective layer thickness is obtained by repeatedly spraying the coating composition until the colorimetric data for L*, a* and b* are the same for the coated black and white parts of the substrate, respectively, thus guaranteeing that no substrate color specific information confounds the pigment specific values. More details are disclosed in the method section of this invention. Thus, the term “masstone color” can be used to determine whether a certain pigment is a black pigment or is a white pigment in the sense of this term.

Preferably,
the at least one pigment P-C1 is selected from the group consisting of iron/chromium oxide compounds, manganese ferrite black oxide, calcium manganese titanium oxide, perylene pigments, azomethine pigments and mixtures thereof, preferably is selected from perylene pigments, azomethine pigments and mixtures thereof, in particular pigments nos. 31 and 32 (PBk 31 and PBk 32; CI names), most preferably is selected from perylene pigments; and/or
the at least one pigment P-C2 is selected from the group consisting of titanium dioxide based or containing pigments, preferably selected from titanium/aluminum/silicon oxide-based pigments and rod-like aluminum-doped titanium dioxide pigments.

A rod-like pigment preferably has a long dimension of 1 to 5 such as 2 to 4 μm and a hart dimension of 0.2 to 0.6, such as 0.3 to 0.5 μm. Preferably, a rod-like pigment has an average D50 value, i.e., median particle size, in the range from 0.01 μm to 1 μm as determined by laser granulometry according to ISO 13320-1 (determined with a CILAS 1064 instrument).

Commercially available pigments P-C2 are e.g. Tipaque Black SG103 (from Ishihara) and Paliogen® Black L0086 from BASF. Commercially available white pigments P-C2 are e.g., selected from Altiris 550 and Altiris 800 (both from Vanator), Tipaque PFR404 (from Ishihara), Ti-Pure® R-906 as well as Kronos® 2310.

The weight ratio of [(P-C1)+(P-C2)]/[(P-A1)+(P-A2)] in the primer coating composition is preferably in the range from 0.005 to 1.2, more preferred in the range from 0.01 to 1.0 and most preferred in the range from 0.015 to 0.75.

Preferably, the primer coating composition further comprises at least one preferably organic or inorganic, more preferably organic, coloring pigment P-C3, which is different from both pigments P-C1 and P-C2 and which is not a carbon black pigment, which is more preferably selected from blue, red and violet organic pigments.

Preferably, the primer coating composition is free or essentially free of any carbon black pigments. “Essentially free” means that no carbon black pigments are added on purpose and that preferably, their amount, if present, is below 0.1 wt.-%, in particular below 0.01 wt.-%, most preferably below 0.001 wt.-%, based on the total weight of the coating composition.

A primer coating obtained from applying the primer coating composition to a substrate has a brightness value L* according to the CIELAB system at 45° of no more than 38. Preferably, the primer coating obtained from applying the primer coating composition to a substrate has a brightness value L* of no more than 35, more preferably of no more than 30. Preferably, the primer coating obtained from applying the primer coating composition to a substrate has a brightness value L* according to the CIELAB system at 45° in a range of from 0.1 to of no more than 38.

Preferably, a primer coating obtained from applying the primer coating composition to a substrate and curing the resulting primer coating film to obtain the primer coating has a brightness value L* according to the CIELAB system at 45° of no more than 38, more preferably of no more than 35, even more preferably of no more than 30. Preferably, curing takes place at about 140° C. for 25 minutes. Preferably, the primer coating obtained from applying the primer coating composition to a substrate and curing the resulting primer coating film to obtain the primer coating has a brightness value L* according to the CIELAB system at 45° in a range of from 0.1 to of no more than 38.

Preferably, a brightness value L* according to the CIELAB system at 45° of no more than 38 is desired in order to ensure that the primer coating is dark in color. Preferably, a brightness value L* according to the CIELAB system at 45° of no more than 38 is achieved by incorporating the at least two kinds of pigments P-C1 and P-C2 in the amounts given hereinbefore and hereinafter into the primer coating composition.

Preferably, a primer coating obtained from applying the primer coating composition to a substrate is able to reflect NIR light, preferably NIR light having a wavelength from 800 to 2500 nm.

Preferably, a primer coating obtained from applying the primer coating composition to a substrate has
a LiDAR reflectivity, measured at an angle of incidence of 0°, of at least 40%, preferably of at least 45%, more preferably of at least 50%, even more preferably of at least 55%, still more preferably of at least 60%, yet more preferably of at least 65%, in particular of at least 70%, and/or
a UV Vis transmission of below 0.005, preferably of below 0.003, more preferably of equal or below 0.002, and/or
an infrared solar reflectance (IRSR) of more than 30%, preferably of more than 35%, even more preferably of more than 40%.

Preferably, a primer coating obtained from applying the primer coating composition to a substrate and curing the resulting primer coating film to obtain the primer coating has a LiDAR reflectivity, measured at an angle of incidence of 0°, of at least 40%, preferably of at least 45%, more preferably of at least 50%, even more preferably of at least 55%, still more preferably of at least 60%, yet more preferably of at least 65%, in particular of at least 70%. Preferably, a primer coating obtained from applying the primer coating composition to a substrate and curing the resulting primer coating film to obtain the primer coating has a UV Vis transmission of below 0.005, preferably of below 0.003. Preferably, a primer coating obtained from applying the primer coating composition to a substrate and curing the resulting primer coating film to obtain the primer coating has an infrared solar reflectance (IRSR) of more than 30%, preferably of more than 35%, even more preferably of more than 40%. Preferably, curing takes place in each case at about 140° C. for 25 minutes.

### Methods of Forming a Primer Coating Film and a Primer Coating Layer

A further subject-matter of the present invention is a method of forming a primer coating film at least partially onto at least one surface of a substrate, wherein said method comprises at least step (a), namely
(a) applying the inventive primer coating composition at least partially onto at least one surface of an optionally pre-coated substrate to form a primer coating film on the surface of the substrate.

A further subject-matter of the present invention is a method of forming a primer coating layer at least partially onto at least one surface of a substrate, wherein said method comprises at least step (a) as defined hereinbefore and at least step (b), namely
(b) curing the primer coating film obtained after step (a) to obtain a primer coating layer.

All preferred embodiments described hereinbefore in connection with the inventive primer coating composition and the preferred embodiments thereof are also preferred embodiments of the inventive methods for preparing a primer coating film and primer a coating layer.

### Primer Coating Film and a Primer Coating Layer

A further subject-matter of the present invention is a coating film obtainable from the inventive primer coating composition or by the inventive method of forming a primer coating film and a coating layer obtainable from the inventive primer coating composition or by the inventive method of forming a primer coating layer.

All preferred embodiments described hereinbefore in connection with the inventive primer coating composition and the inventive methods for preparing a primer coating film and a primer coating layer and in each case the preferred embodiments thereof are also preferred embodiments of the inventive primer coating film and primer coating layer.

### Coated Substrate

A further subject-matter of the present invention is an at least partially coated substrate obtainable by the inventive method of forming a primer coating layer, wherein the substrate as such prior to performing said method preferably is not or essentially not LiDAR-reflective.

All preferred embodiments described hereinbefore in connection with the inventive primer coating composition, the inventive methods for preparing a primer coating film and a primer coating layer, the inventive primer coating film and primer coating layer, and in each case the preferred embodiments thereof are also preferred embodiments of the inventive coated substrate.

### Multilayer Coating System

A further subject-matter of the present invention is a multilayer coating system being present on an optionally pre-coated substrate and comprising at least three coatings layers L1, L2 and L3 being different from one another, namely
a first coating layer L1 applied over at least a portion of an optionally pre-coated substrate,
a second coating layer L2 applied over the first coating layer L1, and
a third top coating layer L3 applied over the second coating layer L2,
wherein the first coating layer L1 is formed from the inventive primer coating composition and the second coating layer L2 is formed from a basecoat composition different from the primer coating composition, and the third coating layer L3 is formed from a topcoat, preferably clearcoat, composition different from both the primer coating composition and from the basecoat composition.

Preferably, at least the second and the third coating layers L2 and L3 are positioned adjacently to each other. More preferably, also the first and the second coating layers L1 and L2 are positioned adjacently to each other.

Preferably, both the primer coating composition used to form the first coating layer L1 and the basecoat composition used to form the second coating layer L2 are free or essentially free of any carbon black. Preferably, also the topcoat composition used to form the third coating layer L3 free or essentially free of any carbon black. “Essentially free” means that no carbon black pigments are added on purpose and that preferably, their amount, if present, is below 0.1 wt.-%, in particular below 0.01 wt.-%, most preferably below 0.001 wt.-%, based on the total weight of the respective coating composition.

All preferred embodiments described hereinbefore in connection with the inventive primer coating composition, the inventive methods for preparing a primer coating film and a primer coating layer, the inventive primer coating film and primer coating layer, the inventive coated substrate, and in each case the preferred embodiments thereof are also preferred embodiments of the inventive multilayer coating system.

Each of the coating compositions used in the inventive method, in particular in each of steps (1) to (3), which will be described hereinafter, and/or for preparing the multilayer coating system can be aqueous (waterborne) or organic solvent(s) based (solventborne, non-aqueous). Preferably, the topcoat, preferably clearcoat, composition is organic solvent(s) based (solventborne, non-aqueous). Preferably, the basecoat composition is aqueous or solventborne, more preferably aqueous.

Preferably, the inventive multilayer coating system is able to reflect NIR light, preferably NIR light having a wavelength from 800 to 2500 nm. In particular, the first coating layer L1 is able to reflect NIR light, preferably NIR light having a wavelength from 800 to 2500 nm.

The inventive multilayer coating system is particularly suitable as a coating of automotive vehicle bodies or parts thereof including respective metallic substrates, but also plastic substrates such as polymeric substrates. Consequently, the preferred substrates are automotive vehicle bodies or parts thereof.

Suitability as metallic substrates used in accordance with the invention are all substrates used customarily and known to the skilled person. The substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Preferably, thermoplastic polymers are used as plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

The substrate used in accordance with the invention is preferably a metallic substrate pretreated with at least one metal phosphate such as zinc phosphate and/or pretreated with at least one an oxalate. A pretreatment of this kind by means of phosphating, which takes place normally after the substrate has been cleaned and before the substrate is electrodeposition-coated, is in particular a pretreatment step that is customary in the automobile industry.

As outlined above the substrate used may be a pre-coated substrate, i.e. a substrate bearing at least one cured coating film. The substrate can be pre-coated with a cured electrodeposition coating layer.

The term “basecoat” is known in the art and, for example, defined in Römpp Lexikon, paints and printing inks, Georg Thieme Verlag, 1998, 10th edition, page 57. A basecoat is therefore in particular used in automotive painting and general industrial paint coloring in order to give a coloring and/or an optical effect by using the basecoat as an intermediate coating composition.

Preferably, the basecoat composition comprises at least one pigment, which is not a carbon black pigment and not a pigment, which is absorptive to NIR radiation, more preferably comprises at least one pigment, and which is transparent or substantially transparent to NIR-radiation or which is reflective or substantially reflective to NIR-radiation. The at least one pigment present in the basecoat composition preferably is a pigment, which is transparent or substantially transparent to NIR-radiation and may be identical to or different from pigment P-C1 being present in the primer coating composition. Preferably, said at least one pigment is selected from perylene pigments, azomethine pigments and mixtures thereof, in particular pigments nos. 31 and 32 (PBk 31 and PBk 32; CI names). In addition, at least one effect pigment such as a metal effect pigment may be additionally or alternatively present in the basecoat composition. In case at least one effect pigment such as a metal effect pigment is present besides at least one pigment, which is transparent or substantially transparent to NIR-radiation such as a perylene pigment, the amount of the effect pigment present in the basecoat composition preferably exceeds the amount of the at least one pigment, which is transparent or substantially transparent to NIR-radiation. Preferably, the metal effect pigment if is present in the form of flakes, more preferably in the form of opaque flakes. Preferably, said pigment has a D50 value, i.e., median particle size, in the range from 5 μm to 100 μm and even more preferred in the range from 15 μm to 30 μm as determined by laser granulometry according to ISO 13320-1 (determined with a CILAS 1064 instrument).

A skilled person is familiar with the concept of the effect pigments. A corresponding definition is found for example in Römpp Lexikon, Lacke und Druckfarben, Georg Thieme Verlag, 1998, 10th edition, pages 176 and 471. A definition of pigments in general, and further particularizations thereof, are governed in DIN 55943 (date: October 2001). Effect pigments are preferably pigments which impart optical effect or both color and optical effect, especially optical effect. The terms “optical effect and color pigment”, “optical effect pigment” and “effect pigment” are therefore preferably interchangeable.

The term “metal effect pigment” is used in accordance with EN ISO 18451-1:2019 (Pigments, dyestuffs and extenders—Terminology—Part 1). They are defined as platelet-shaped pigments consisting of metal. In the present invention the term “consisting of metal” does not exclude surface modifications of the metal effect pigments such as the presence of additional oxide layers, as e.g., a silicon dioxide layer. The term “metal” as used in the term “metal effect pigments” includes metals and metal alloys, likewise. Metal effect pigments—as already lined out above—can be orientated in parallel and show then metallic gloss due to light reflection at the flakes.

Typical metals and alloys used in metal effect pigments are aluminum, and its alloys. Most suitable and preferred in the present invention are platelet-shaped aluminum effect pigments, which might be coated or uncoated and which are preferably coated, particularly in case of the preferred aluminum pigments to inhibit their reaction with water in aqueous basecoat compositions. Such inhibition can e.g., be achieved by the use of organo-phosphorous stabilization; passivating the aluminum pigments with a conversion layer, e.g., by chromating; encapsulation with a protective layer, such as a polymer coating or a silica coating (Peter Wißling, “Metallic Effect Pigments”, Vincentz Network 2006, pp. 85-89). Such aluminum effect pigments are e.g., commercially available from ECKART GmbH (Germany) under the tradenames STAPA® Hydroxal (stabilized), STAPA® Hydrolux (chromated) and STAPA® Hydrolan (silica encapsulated). Further modification of the pigment surfaces is also possible, e.g., by modification with non-polar groups, such as alkyl groups leading to a so-called semi-leafing effect.

The metal effect pigments, particularly aluminum effect pigments, may be coated with an oxide layer, such as a silica layer, which further helps to stabilize the pigments against mechanical impact und particularly improves circulation line stability. In the present invention silica encapsulated aluminum metal effect pigments are most preferred. Preferably, the amount of silica, based on the sum of the amounts of aluminum and silica in such preferred aluminum effect pigments ranges from 3 to 15 wt.-% more preferred from 5 to 12 wt.-% and most preferred from 6 to 10 wt.-%. However, the term “metal effect pigment” encompasses such coated pigments and the total weight of such coated metal effect pigment is understood to be the weight of the metal effect pigment. Thus, the weight includes the coating material.

Alternatively, or additionally, the basecoat composition comprises at least one pearlescent or interference pigment. Preferably, such a pigment is present in the form of flakes, more preferably in the form of non-opaque flakes. Preferably, said pigment is selected from mica pigments, which are coated with at least one kind of metal or semimetal oxide such as aluminum oxide and/or silica. Examples of commercially available pigments for use as pigments B-C1 are e.g. Mearlin® Bright Silver 1303Z-Ext (mica platelet flakes coated with titanium dioxide and/or iron oxide), Iriodin® 9225 Rutile Blue Pearl SW (mica flakes) and Iriodin® 9605 Blue-Shade Silver SW (mica flakes). Other examples are Mearlin® Bright Silver 1303V and Iriodin® 9602.

### Method for Preparing the Multilayer Coating System

A further subject-matter of the present invention is a method for preparing the inventive multilayer coating system comprising at least steps (1), (2), (3) and (4), namely
(1) applying an inventive primer coating composition to at least a portion of an optionally pre-coated substrate and forming a first coating film on at least a portion of the optionally pre-coated substrate,
(2) applying a basecoat composition different from the primer coating composition applied in step (1) to the first coating film present on the substrate obtained after step (1) and forming a second coating film, which preferably is adjacent to the first coating film,
(3) applying a coating composition different from the compositions applied in steps (1) and (2) to the second coating film present on the substrate obtained after step (2) and forming a third coating film, which is preferably adjacent to the second coating film, wherein said coating composition is preferably a clearcoat composition, and
(4) jointly curing at least the second and third coating films applied in steps (2) and (3) and optionally also the first coating film applied in step (1) in case said first coating film was not cured prior to performing of step (2) to obtain a multilayer coating system comprising at least the first, the second and the third coating layers L1, L2 and L3.

All preferred embodiments described hereinbefore in connection with the inventive primer coating composition, the inventive methods for preparing a primer coating film and a primer coating layer, the inventive primer coating film and primer coating layer, the inventive coated substrate, the inventive multilayer coating system, and in each case the preferred embodiments thereof are also preferred embodiments of the method for preparing the inventive multilayer coating system.

Curing is preferably selected from chemical curing such as chemical crosslinking, radiation curing, and/or physically drying (non-chemical curing), in each case at room temperature or at an elevated temperature, more preferably is selected from chemical curing such as chemical crosslinking, and/or physically drying (non-chemical curing), in each case at room temperature or at an elevated temperature. The curing temperature may vary from 80° C. to 160° C.

Each of the coating compositions used in steps (1), (2), and (3) of the inventive method and/or used for preparing coating layers L1, L2 and L3 of the inventive multilayer coating system may contain—besides the constituents outlined in more detail hereinafter—one or more commonly used additives depending on the desired application. For example, each of the coating compositions may comprise independently of one another at least one additive selected from the group consisting of reactive diluents, catalysts, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, siccatives, thickeners, biocides and/or matting agents. They can be used in known and customary proportions. Preferably, their content, based on the total weight of each the coating composition is 0.01 to 20.0 wt.-%, more preferably 0.05 to 15.0 wt.-%, particularly preferably 0.1 to 10.0% By weight, most preferably from 0.1 to 7.5% by weight, especially from 0.1 to 5.0% by weight and most preferably from 0.1 to 2.5% by weight.

### Use

A further subject-matter of the present invention is a use of the inventive coating film or layer and/or of the at least partially coated inventive substrate and/or of an object produced from said substrate and/or of the inventive multilayer coating system in LiDAR visibility applications concerning vehicles and parts thereof.

All preferred embodiments described hereinbefore in connection with the inventive primer coating composition, the inventive methods for preparing a primer coating film and a primer coating layer, the inventive primer coating film and primer coating layer, the inventive coated substrate, the inventive multilayer coating system, the method for preparing the inventive multilayer coating system, and in each case the preferred embodiments thereof are also preferred embodiments of the inventive use.

The inventive use allows a benefit from better infrared light and LiDAR visibility, in particular for autonomous systems such as self-driving vehicles and vehicles with ADAS.

### METHODS

### 1. Determining the Non-Volatile Fraction

The amount of solid content (non-volatile matter, solid fraction) including the total solid content is determined via DIN EN ISO 3251:2019-09 at 110° C. for 60 min.

### 2. Measurement of Color Values

The L*a*b* color space or the L*a*b* color model (i.e. the CIELAB color model) is known to a person skilled in the art. The L*a*b* color model is standardized e.g., in DIN EN ISO/CIE 11664-4:2020-03. Each perceivable color in the L*a*b*-color space is described by a specific color location with the coordinates {L*,a*,b*} in a three-dimensional coordinate system. The a*-axis describes the green or red portion of a color, with negative values representing green and positive values representing red. The b*-axis describes the blue or yellow portion of a color, with negative values for blue and positive values for yellow. Lower numbers thus indicate a more bluish color. The L*-axis is perpendicular to this plane and represents the lightness (brightness). The color value L* is determined in accordance with ASTM E 284-81a. The values are measured by making use of the instrument BYK-mac i (BYK-Gardner) following ASTM D 2244, E308, E1164 and E2194. Analysis of the samples is done in accordance with color, sparkle and graininess measurement with the BYK-mac i spectrophotometer standard operating procedure. The samples to be analyzed are carefully wiped down with a microfiber cloth. The BYK-mac i instrument is then placed onto the substrate surface and performs a measurement using D65 light source at 15°, 45°, and 110° angles with data recorded for each angle. This measurement is taken on an individual panel in at least three different positions and values are averaged over the trials and reported. The weighted average of the color differences of two colors (mDE*) can be calculated by using the formula

mDE=\sqrt{dL²+da²+db²},

where dL, da and db are differences between L, a and b values of two colors respectively.

### 3. Determination of LiDAR Reflectivity

LiDAR measurements on primer or multilayer coatings at different angles were carried out using a Velodyne VLP-16 instrument (905 nm), measured at distance of 1 m. The instrument is calibrated using Permaflect 10%, 50% and 80% calibration tiles to give 10%, 50% and 80% reflection respectively at 0° AOI.

### 4. UV Measurements

For UV measurements, the primer is sprayed on a Tedlar film TTR10SG4 with 14 μm film builds. The measurement was carried out using a Shimadzu Scientific 2600 series device. UV transmission is measured from 290 nm to 700 nm with a blank film as control. The UV reflectance value is obtained by subtracting the absorbance of the plain Tedlar Film.

### 5. Total Solar Reflectance (TSR)

Total solar reflectance was measured according to ASTM E903.

### 6. IRSR (Infrared Solar Reflectance)

IRSR (Infrared solar reflectance) was calculated by truncating visible range (300 nm-700 nm) via the following formula:

$${ρ}_{s} = ( {\sum }_{i = 1}^{n} ρ ( {λ}_{i} ) {E}_{λ i} Δ {λ}_{i} ) / ( {\sum }_{i = 1}^{n} {E}_{λ i} Δ {λ}_{i} ) ,$$

wherein
ρ(λᵢ) is % reflectance of the coating layer at a particular wavelength λ
E_{λi} is the spectral solar irradiance at that wavelength.
Δλᵢ refers to the step change in the wavelength for the irradiance measurement.

### 7. Determination of the Masstone Color of the Pigment(s) P-C1 and P-C2

The “masstone color” is determined as the color which is obtained by applying a coating layer containing the respective pigment to completely cover a black and a white substrate (typically a so-called “checker tile” being partially black and partially white is used) in a layer thickness, where no black and white color information shines through (full hiding). The coating composition used to determine the mass tone color for the aim of the present invention is described in the Table below. For each pigment P-C1 or P-C2, or for each mixture of pigments P-C1 or mixture of pigments P-C2, a piment paste is prepared by vibroshaking. The ingredients in each pigment paste were: 30 parts by weight of the respective solid pigment (i.e., pigment P-C1 or pigment P-C2 or mixture of pigments P-C1 or mixture of pigments P-C2, 15 parts by weight of water, 2 parts by weight of Butyl-Cellosolve, 39.2 parts by weight of a polyurethane grinding resin, 4.8 parts by weight of Pluracol 1010 Polyol and 9 parts by weight of Byk 184. The pigment paste was incorporated into the coating composition such that the pigment volume concentration is approx. 20%. The respective layer thickness is obtained by repeatedly spraying the coating composition until the colorimetric data for L*, a* and b* are the same for the coated black and white parts of the substrate, respectively, thus guaranteeing that no substrate color specific information confounds the pigment specific values. Typically, this is achieved at a coating thickness of about 20 μm.

TABLE
Coating composition used for determining the masstone color

| | | Basecoat |
|---|---|---|
| | | starting |
| | Ingredients | formulation |
| 1 | synthetic layered silicate thickening agent | 0.81 |
| | incorporating an inorganic polyphosphate peptiser | |
| 2 | propylene started polypropylene oxide (Mₙ ≈ 1,000) | 0.77 |
| 3 | tetramethyl decin diol (52 wt.-% in 2-butoxyethanol)/ | 0.66 |
| | wetting agent | |
| 4 | IPDI-based polyurethane (solids: 27 wt.-%); acid | 23.11 |
| | number 10 mg OH/g (A1) | |
| 5 | 2-ethylhexanol | 3.10 |
| 6 | polyester (solids: 60 wt.-%); acid number 32 mg | 0.39 |
| | KOH/g; M_{w} 21,000-36,000 (A1) | |
| 7 | highly alkylated, mixed ether (methyl/n-butyl) | 4.48 |
| | melamine crosslinker (solids: ≥97 wt.-%) (A2) | |
| 8 | Butyl-Cellosolve | 0.73 |
| 9 | dimethyl ethanolamine | 0.06 |
| 10 | TMXDI-based polyurethane (solids 35.5 wt.-%); | 6.66 |
| | hydroxyl number 109 mg OH/g; acid number 33.5 | |
| | mg OH/g (A1) | |
| 11 | ethylene glycol monobutyl ether | 1.39 |
| 12 | amine-neutralized p-toluenesulfonic acid catalyst | 0.78 |
| 13 | non-ionic medium pseudoplastic rheology modifying | 0.11 |
| | polyurethane emulsion (solids: 40 wt. % in | |
| | water/butyldiglycol) (A1) | |
| 14 | acrylic-copolymer thickener (solids: 30 wt.-% in | 0.31 |
| | water) | |
| 15 | water, deionized | 34.83 |

### EXAMPLES

The following examples further illustrate the invention but are not to be construed as limiting its scope. ‘Pbw’ means parts by weight. If not defined otherwise, ‘parts’ means ‘parts by weight’.

### 1. Preparation of Primer Coating Compositions

1.1 A comparative primer coating composition P1C1 has been prepared by mixing the constituents listed in Table 1 in this order.

TABLE 1
Constituents of P1C1

| | Amount |
|---|---|
| Constituent | [pbw] |
| White pigment paste WP1 | 35.10 |
| Black pigment paste BP1 | 30.97 |
| Binder dispersion BD1 | 27.51 |
| Deionized water | 3.13 |
| Crosslinker dispersion CD1 | 14.89 |
| Deionized water | 6.66 |
| 2-Ethylhexanol | 1.52 |
| OS1 | 1.90 |
| OS2 | 1.52 |
| N,N′-Dimethylethanolamine | 0.001 |
| Ethylene glycol monobutyl ether | 0.001 |
| Deionized water | 5.00 |

White pigment paste WP1 has a solid content of 63 wt.-% and contains 49 wt.-%, based on the total weight of WP1, of a commercial titanium dioxide white reflective pigment (Kronos® 2310). Black pigment paste BP1 contains 10 wt.-%, based on its total weight, of Monarch® 1400, a commercially available carbon black pigment from Cabot. The binder dispersion BD1 contains an acrylic resin and has a solid content (resin solids) of 27 wt.-%. The crosslinker dispersion CD1 contains a crosslinker resin (Cymel® 203) as well as a polyester resin and has a total solid content (resin solids) of 55.54 wt.-%. OS1 is a mixture of organic solvents commercially available as Isopar® and as Shellsol® OMS. OS2 is a mixture of organic solvents commercially available as Exxal® 13.

1.2 An inventive primer coating composition P1I1 has been prepared by mixing the constituents listed in Table 2a in this order.

TABLE 2a
Constituents of P1I1

| | Amount |
|---|---|
| Constituent | [pbw] |
| White pigment paste WP1 | 31.25 |
| Binder dispersion BD1 | 37.01 |
| Deionized water | 4.20 |
| Crosslinker dispersion CD1 | 20.03 |
| Deionized water | 8.96 |
| 2-Ethylhexanol | 2.04 |
| OS3 | 2.56 |
| OS2 | 2.04 |
| N,N′-Dimethylethanolamine | 0.001 |
| Ethylene glycol monobutyl ether | 0.001 |
| Deionized water | 6.72 |
| Black pigment paste BP2 | 60.71 |
| White pigment paste WP1 | 24.86 |
| Color pigment paste CP1 | 15.51 |
| Color pigment paste CP2 | 1.92 |

WP1, BD1, CD1 and OS2 have already been identified above in connection with P1C1. OS3 is a mixture of organic solvents commercially available as Isopar®. Black pigment paste BP2 contains 18.5 wt.-%, based on its total weight, of Paliogen® L0086, a commercially available organic black pigment from BASF, which is a non-carbon black pigment. BP2 further contains 21 wt.-% polyacrylic resin solids, based on its total weight. Color pigment paste CP1 is a commercially available pigment paste (Hostaperm® Scarlet GO) containing a red pigment. CP1 contains 25 wt.-% pigment and 22 wt.-% of a polyurethane resin, in each case based on its total weight Color pigment paste CP2 contains a phthalocyanine blue pigment. CP2 contains 27.47 wt.-% pigment and 17 wt.-% of a polyacrylic resin, in each case based on its total weight.

1.3 Inventive primer coating compositions P1I2 and P1I3 have been prepared in the same manner as described above for P1I1.

In case of P1I2 the constituents as listed in Table 2b have been used.

TABLE 2b
Constituents of P1I2

| | Amount |
|---|---|
| Constituent | [pbw] |
| White pigment paste WP1 | 55.0 |
| Binder dispersion BD1 | 170.52 |
| Deionized water | 19.35 |
| Crosslinker dispersion CD1 | 92.28 |
| Deionized water | 41.28 |
| 2-Ethylhexanol | 9.40 |
| OS3 | 11.79 |
| OS2 | 9.40 |
| N,N′-Dimethylethanolamine | 0.005 |
| Ethylene glycol monobutyl ether | 0.005 |
| Deionized water | 30.96 |
| Black pigment paste BP3 | 278 |

BP3 contains an inorganic non-carbon black pigment, namely Tipaque® black SG103 (Calcium Manganese Titanium Oxide Black Pigment) from Ishihara Sangyo Kaisha Ltd, Japan. BP3 contains 30 wt.-% of Tipaque® black SG103.

In case of P1I3 the constituents as listed in Table 2c have been used.

TABLE 2c
Constituents of P1I3

| | Amount |
|---|---|
| Constituent | [pbw] |
| White pigment paste WP2 | 50.0 |
| Binder dispersion BD1 | 37.01 |
| Deionized water | 4.20 |
| Crosslinker dispersion CD1 | 20.03 |
| Deionized water | 8.96 |
| 2-Ethylhexanol | 2.04 |
| OS3 | 2.56 |
| OS2 | 2.04 |
| N,N′-Dimethylethanolamine | 0.001 |
| Ethylene glycol monobutyl ether | 0.001 |
| Deionized water | 6.72 |
| Black pigment paste BP2 | 60.71 |

WP2 contains Tipaque® PFR404 (Rutile type TiO₂) from Ishihara Sangyo Kaisha Ltd, Japan as white reflective pigment instead of Kronos® 2310. Tipaque® PFR404 has a larger average particle size than Kronos® 2310. WP2 contains 30 wt.-% of Tipaque® PFR404.

### 2. Investigation of Properties of the Primers

In Table 3 a standard primer (comparative example P1C1) is compared with the inventive primers P1I1, P1I2 and P1I3. All primers had the same brightness (L*=about 25 at 45°). The properties indicated in the Table were measured as described hereinbefore in the ‘methods’ section.

TABLE 3

| | P1C1 | | | |
|---|---|---|---|---|
| Property | (comparative) | P1I3 | P1I2 | P1I1 |
| Lidar Reflectivity at | 3.2% | 69% | 47.80% | 71.7% |
| 905 nm, 0° AOI | | | | |
| (angle of incidence) | | | | |
| UV Vis | <0.002 | <0.02 | <0.02 | <0.02 |
| Transmission at 14 | throughout | throughout | throughout | throughout |
| μm (280 nm-500 | | | | |
| nm) | | | | |
| IRSR (700 nm- | <3% | 41.2% | 34.7% | 42% |
| 2500 nm) | | | | |

It is evident from Table 3 that compared to P1C1 with each of P1I1, P1I2 and P1I3 a significantly higher Lidar reflectivity and significantly better infrared solar reflectance (IRSR) was achieved. The best performance was observed for P1I1.

In Table 4 the color values of primers P1I1 and P1C1 are compared.

TABLE 4

| Color Values | P1C1 | P1I1 |
|---|---|---|
| L* at 45° | 25.48 | 25.92 |
| a* | −0.88 | −0.77 |
| b* | −3.08 | −2.08 |

The weighted average of the color difference (mDE*) in color value between P1C1 and P1I1 is very small (mDE* is only 0.72).

### 3. Investigation of Properties of Multilayer Coating Systems

In Table 5 properties of multilayer coating systems obtained from making use of one of P1C1 and P1I1 are illustrated and compared to each other. On a pre-treated steel-panel coated with a cathodic electrodeposition coating layer using Cathoguard 800, a primer layer made from P1C1 or P1I1 is formed and cured for 25 minutes at about 140° C. (about 20 to 23 μm dry film thickness). Then, a basecoat film formed from a commercially available basecoat composition containing a NIR-transparent black pigment (Paliogen® L0086) (p/b ratio 0.1) is applied onto the cured primer film and flashed off for 7 minutes at about 71° C. Then, a clearcoat composition is applied onto the flashed off basecoat film. The two films are then jointly cured at about 140° C. for 25 minutes (about 20 to 23 μm dry basecoat film thickness and about 50 μm dry clearcoat film thickness). A commercial clearcoat product (ProGloss/2K4) was used. All compositions were applied by pneumatic spraying. The clearcoat layer is a transparent layer and is also transparent to IR radiation. The obtained multilayer coating systems (MLCS) are then investigated. The properties indicated in the Table 5 were measured as described hereinbefore in the ‘methods’ section.

TABLE 5

| | MLCS containing | MLCS containing |
|---|---|---|
| | P1C1 (comparative) | P1I1 |
| Lidar Reflectivity at 905 nm, | 11% | 76% |
| 0° AOI (angle of incidence) | | |
| Color values | | |
| L* at 45° | 4.77 | 4.97 |
| a* | 0.71 | 0.36 |
| b* | 1.53 | 1.85 |

The weighted average of the color difference (mDE*) in color value between MLCS making use of P1C1 and MLCS making use of P1I1 is very small (mDE* is only 0.48). It has been found that this in particular achieved by adding IR transparent red and blue pigments into the primer to achieve the desired color space.

It is further evident from Table 5 that compared to P1C1 with P1I1 a significantly higher Lidar reflectivity was achieved.

1. A primer coating composition, which is free of or essentially free of metal effect pigments, comprising
as at least one constituent P-A, at least one film-forming polymer P-A1, and in case of P-A1 being externally crosslinkable, at least one crosslinking agent P-A2,
water and/or one or more organic solvents as constituent(s) P-B,
a pigment mixture as at least one constituent P-C comprising at least two kinds of pigments being different from one another, namely at least one organic black or inorganic black pigment P-C1, which is not a carbon black pigment, and which is transparent or substantially transparent to NIR-radiation or which is reflective or substantially reflective to NIR-radiation, and at least one inorganic white pigment P-C2, which is reflective or substantially reflective to NIR-radiation,
wherein pigment P-C1 is present in an amount in a range of from 0.1 to 20.0 wt.-%, based on the total weight of the primer coating composition, and pigment P-C2 is present in an amount in a range from 0.2 to 40.0 wt.-%, based on the total weight of the primer coating composition, and
wherein a primer coating obtained from applying the primer coating composition to a substrate has a brightness value L* according to the CIELAB system at 450 of no more than 38.

2. The primer coating composition according to claim 1, wherein the amount of pigment P-C2 in the primer coating composition exceeds the amount of pigment P-C1.

3. The primer coating composition according to claim 1, wherein it further comprises at least one organic or inorganic, coloring pigment P-C3, which is different from both pigments P-C1 and P-C2 and which is not a carbon black pigment.

4. The primer coating composition according to claim 1, wherein
the at least one black pigment P-C1 is a black pigment having a masstone color according to the CIELAB system at 45° with the values of L*<17, a*>−4 and <9, and b*>−4 and <9 and in that
the at least one white pigment P-C2 is a white pigment having a masstone color according to the CIELAB system at 45° with the values of L*>85, a*>−2 and <2, and b*>0 and <6.

5. The primer coating composition according to claim 1, wherein it is free or essentially free of any carbon black pigments.

6. The primer coating composition according to claim 1, wherein
the at least one pigment P-C1 is selected from the group consisting of iron/chromium oxide compounds, manganese ferrite black oxide, calcium manganese titanium oxide, perylene pigments, azomethine pigments and mixtures thereof, and/or
the at least one pigment P-C2 is selected from the group consisting of titanium dioxide based or containing pigments.

7. The primer coating composition according to claim 1, wherein a primer coating obtained from applying the primer coating composition to a substrate has
a LiDAR reflectivity, measured at an angle of incidence of 0°, of at least 40%, and/or
a UV Vis transmission of below 0.005, and/or
an infrared solar reflectance (IRSR) of more than 30%.

8. A method of forming a primer coating film at least partially onto at least one surface of a substrate, wherein the method comprises at least step (a), namely
(a) applying the primer coating composition according to claim 1 at least partially onto at least one surface of an optionally pre-coated substrate to form a primer coating film on the surface of the substrate.

9. A method of forming a primer coating layer at least partially onto at least one surface of a substrate, wherein the method comprises at least step (a) of claim 8 and at least step (b), namely
(b) curing the primer coating film obtained after step (a) to obtain a primer coating layer.

10. A coating film obtained from the primer coating composition according to the method of claim 8.

11. An at least partially coated substrate obtained by the method according to claim 10, wherein the substrate as such prior to performing the coating method is not or essentially not LiDAR-reflective.

12. A multilayer coating system being present on an optionally pre-coated substrate and comprising at least three coatings layers L1, L2 and L3 being different from one another, namely
a first coating layer L1 applied over at least a portion of an optionally pre-coated substrate,
a second coating layer L2 applied over the first coating layer L1, and
a third top coating layer L3 applied over the second coating layer L2,
wherein the first coating layer L1 is formed from the primer coating composition according to claim 1 and the second coating layer L2 is formed from a basecoat composition different from the primer coating composition, and the third coating layer L3 is formed from a topcoat composition different from both the primer coating composition and from the basecoat composition.

13. The multilayer coating system according to claim 12, wherein the basecoat composition comprises at least one pigment, which is not a carbon black pigment and not a pigment, which is absorptive to NIR radiation, which is transparent or substantially transparent to NIR-radiation or which is reflective or substantially reflective to NIR-radiation.

14. A method for preparing the multilayer coating system according to claim 12 comprising at least steps (1), (2), (3) and (4), namely
(1) applying a primer coating composition to at least a portion of an optionally pre-coated substrate and forming a first coating film on at least a portion of the optionally pre-coated substrate,
(2) applying a basecoat composition different from the primer coating composition applied in step (1) to the first coating film present on the substrate obtained after step (1) and forming a second coating film,
(3) applying a coating composition different from the compositions applied in steps (1) and (2) to the second coating film present on the substrate obtained after step (2) and forming a third coating film, and
(4) jointly curing at least the second and third coating films applied in steps (2) and (3) and optionally also the first coating film applied in step (1) in case the first coating film was not cured prior to performing of step (2) to obtain a multilayer coating system comprising at least the first, the second and the third coating layers L1, L2 and L3.

15. A method of using the coating film or layer of claim 10 the method comprising using the coating film or layer in LiDAR visibility applications concerning vehicles and parts thereof.

16. The primer coating composition according to claim 2, wherein the relative weight ratio of pigment P-C2 to P-C1 is in a range of from 15:1 to 1.1:1

17. The primer coating composition according to claim 3, wherein the organic coloring pigment P-C3, which is different from both pigments P-C1 and P-C2 and which is not a carbon black pigment, selected from the group consisting of blue, red and violet organic pigments.

18. The primer coating composition according to claim 6, wherein
the at least one pigment P-C1 is selected from the group consisting of perylene pigments, azomethine pigments and mixtures thereof, and/or
the at least one pigment P-C2 is selected from the group consisting of titanium/aluminum/silicon oxide-based pigments and rod-like aluminum-doped titanium dioxide pigments.
